(19) United States
(12) Patent Application Publication
(10) Pub. No.: US 2021/0351807 A1
(43) Pub. Date: Nov. 11, 2021

(54) Portable Microphone Stand Bag Assembly

(71) Applicant: Thomas V. Lopez, Phoenix, AZ (US)

(72) Inventor: Thomas V. Lopez, Phoenix, AZ (US)

(21) Appl. No.: 16/867,581

(22) Filed: May 6, 2020

(51) Int. Cl. H04B 1/3888; H04R 1/08; A45C 11/00

(52) U.S. Cl. CPC H04B 1/3888; A45C 2011/002; A45C 11/00; H04R 1/08

(57) ABSTRACT

The present invention relates to a bag or case used to store and carry a microphone stand. Most of the microphone stand carry bags are only suitable to carry the boom and poles of the stand and are not designed for the stand base which is mostly circular and perpendicularly attached to the microphone stand poles. The portable microphone stand bag of present invention resolves the above described problems and provides better user experience. The portable microphone stand bag of present invention includes assembly that consists of an upper compartment and a lower compartment. The advantage of the present invention is that the microphone stand, and the base can be securely stored and carried to any location with ease and comfort. The unique upper and lower compartment of the bag provides an equally distributed balanced load and makes it easy to carry the bag.

### CROSS-REFERENCE TO RELATED APPLICATIONS

No related applications are previously filed.

### TITLE OF THE INVENTION

Portable Microphone Stand Bag Assembly

### TECHNICAL FIELD OF THE INVENTION

The present invention relates to the field of bags and cases and, more particularly, relates to a bag or case used to store and carry a microphone stand and parts thereof.

### BACKGROUND OF THE INVENTION

A microphone stand is used to hold and position the microphone and is an essential requirement in a variety of performances, presentation and studio situations. People who frequent use the microphone system for different purposes and frequently travel from one place to another place must carry the microphone stand system using a bag. Traditionally, microphone stands are carried in different types of carry bags and cases. Most of the microphone stand carry bags are only suitable to carry the boom and poles of the stand and are not designed for the stand base which is mostly circular and perpendicularly attached to the microphone stand poles. A traditional microphone stand bag or case in which the stand base and the other equipment of the microphone stand can be randomly stored, may not always be easy to carry and may provide additional unwanted interior space that would lead to displacement of the equipment and would further lead to scratches and dings when the bag or case is carried from one place to another place. Similarly, another disadvantage of the traditional microphone stand bags or cases is that they would occupy more space and would be inconvenient for the user.

None of the prior art inventions and patents, taken either alone or in combination, is effective to overcome the identified defects of storing and carrying a microphone stand with ease. Most microphone stand bags, or cases of the prior art do not provide a special compartment to the stand base so that the microphone stand equipment can be conveniently carried without any scratches and dings.

Hence, the present invention proposes to resolve the existent technical difficulties to eliminate the shortcomings of prior art. The present invention provides a portable microphone stand bag assembly that consists of an upper compartment and a lower compartment. The upper compartment is elongated and rectangularly built with a closable opening which is useful to store the boom and other elongated equipment of the microphone stand. The lower compartment is circularly built and is located at the lower central portion of the elongated upper compartment. The lower compartment further consists of a closable opening around the outer circumference of the lower compartment in which the microphone stand base can be stored.

### SUMMARY OF THE INVENTION

Embodiments of the invention solve the above-mentioned problems by providing a portable microphone stand bag assembly that includes an upper compartment and a lower compartment. The upper compartment is elongated in manner and rectangularly built with a closable opening on the upper surface of the upper compartment. The upper compartment is useful to store the boom and other elongated equipment of the microphone stand. The lower compartment of the microphone stand bag assembly is circularly built and is located at the lower central portion of the elongated upper compartment. The lower compartment further consists of a closable opening around the outer circumference of the lower compartment in which the microphone stand base can be stored. The upper surface of the lower compartment further comprises plurality of handle means that are useful to carry the bag in a balanced manner.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

Embodiments of the invention are described in detail below with reference to the attached drawing figures, wherein:

FIG. 1 is a lower perspective illustration of the portable microphone stand bag assembly.

FIG. 2 is an upper perspective illustration of the portable microphone stand bag assembly.

FIG. 3 is an upper perspective illustration of the portable microphone stand bag assembly further visualizing the closable opening of the upper compartment.

FIG. 4 is a lower perspective illustration of the portable microphone stand bag assembly further visualizing the lower compartment in an open condition.

FIG. 5 is an upper perspective illustration of the portable microphone stand bag assembly and a microphone stand elongated member further visualizing the manner of storage.

FIG. 6 is a lower perspective illustration of the portable microphone stand bag assembly and the microphone stand base further visualizing the manner of storage.

The drawing figures do not limit embodiments the invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

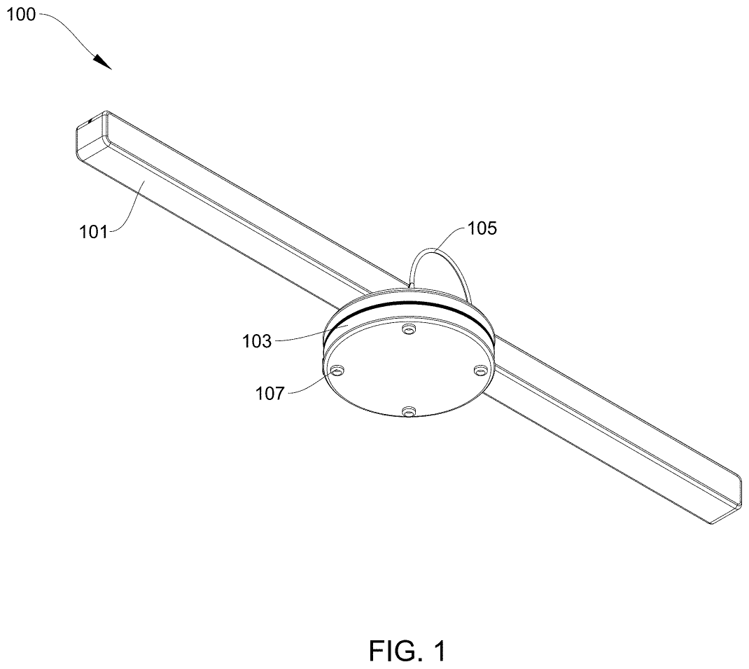

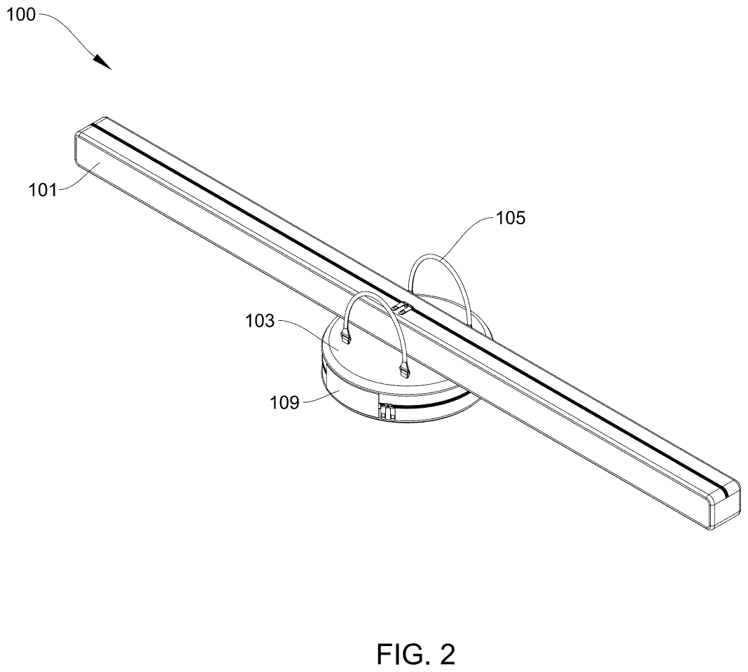

Turning to the Figures, and specifically FIG. 1 and FIG. 2, embodiments of the present invention comprise a portable microphone stand bag assembly 100. The bag assembly 100 comprises an elongated rectangularly built upper compartment 101 presenting an upper surface and a lower surface, wherein the said upper surface of the upper compartment 101 consists of a closable opening. The bag assembly 100 further comprises a circularly built lower compartment 103 presenting an upper surface and a lower surface, wherein the said upper surface of the said circularly built lower compartment 103 is attached at the said lower surface of the said elongated rectangularly built upper compartment 101. In addition, the circularly built lower compartment 103 has a closable opening around the outer circumference 109 of the said circularly built lower compartment 103, wherein the said upper surface of the said circularly built lower compartment 103 further includes plurality of handle means 105 that are useful to carry the bag in a balanced manner. Furthermore, the said lower surface of the said circularly built lower compartment 103 further includes plurality of knob means 107 that are useful to protect the said lower surface of the said circularly built lower compartment and the whole microphone stand bag assembly.

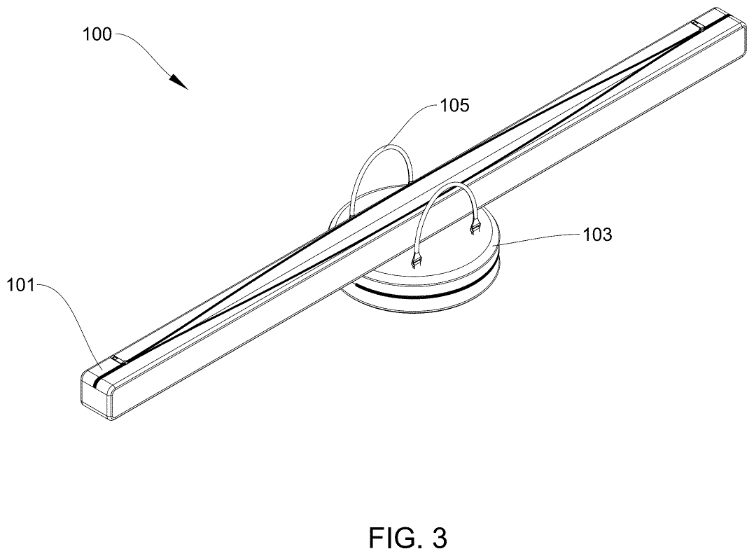

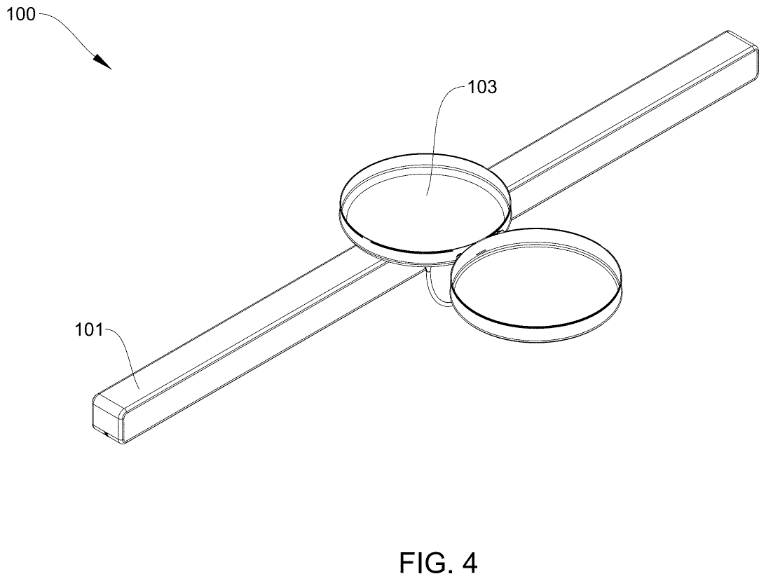

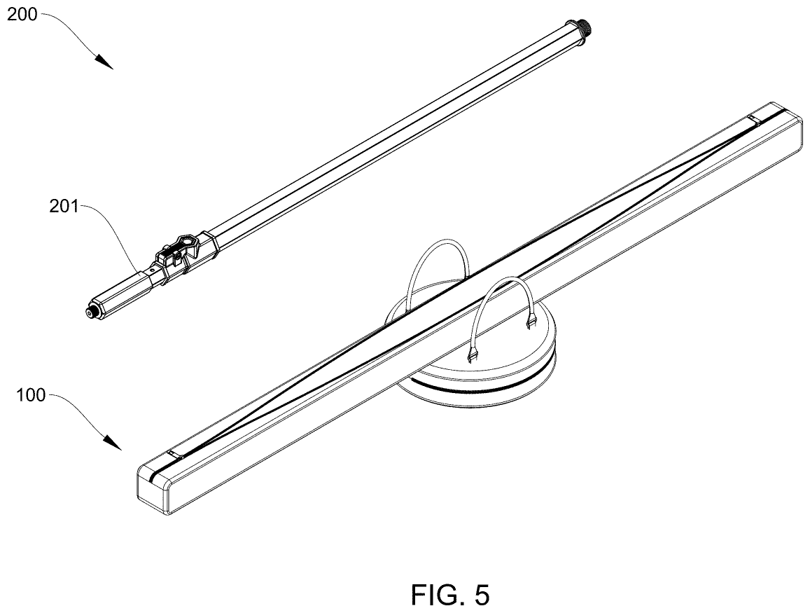

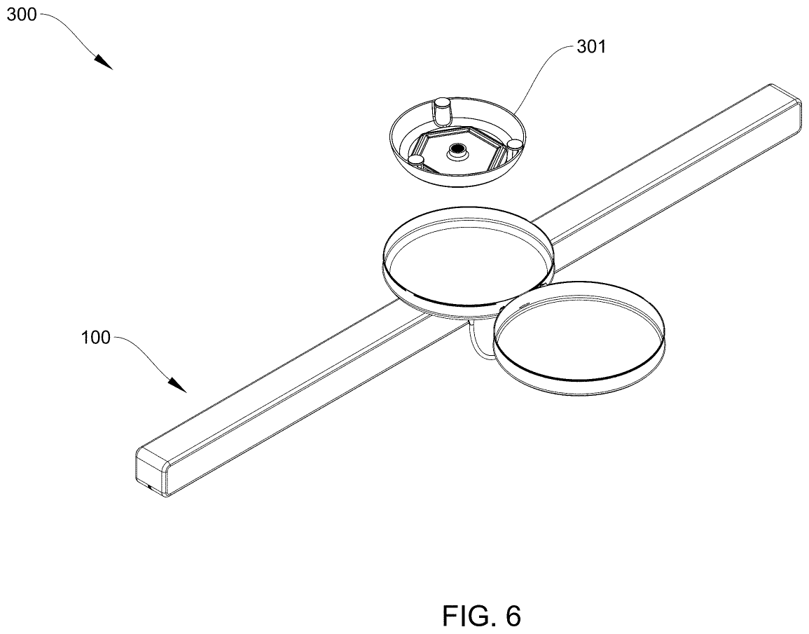

Now, referring to FIG. 3 and FIG. 5, in a preferred embodiment of the present invention, the upper surface of the upper compartment 101 consists of a closable opening, wherein a microphone stand pole or boom 201 is stored in the upper compartment 101 of the microphone stand bag assembly 100. Similarly, FIG. 4 and FIG. 6 provides illustration of another preferred embodiment wherein the circularly built lower compartment 103 has a closable opening around the outer circumference 109 of the said circularly built lower compartment 103, wherein the said circularly built lower compartment 103 is useful to store the base of the microphone stand 301.

In one embodiment of the present invention, the unique upper 101 and lower compartment 103 of the microphone stand bag assembly 100 provides an equally distributed balanced load and makes it easy to the user while carrying the bag 100.

In another embodiment of the present invention, the plurality of handle means 105 provide a balanced and stable grip to the user when carrying the bag 100 from one location to another location.

In further embodiment of the present invention, the microphone stand bag assembly 100 is formed of a material, such as canvas, cotton duck, cotton, polyester, nylon, ballistic nylon, cordura, other fabric, or a combination thereof. At least a portion of the microphone stand bag assembly 100 may be reinforced with a durable waterproof material, such as a polymer or a metal. Portions of the microphone stand bag assembly 100 may be rigid or semi-rigid and may be formed of a plastic or other polymer.

In another embodiment of the present invention, the interior of the upper compartment 101 and lower compartment 102 of the microphone stand bag assembly 100 is formed of a heavy-duty form material that acts as a shockproof and keeps all the parts of the microphone stand safe and undamaged even in a long period of travel.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A portable microphone stand bag assembly comprising:
a) an elongated rectangularly built upper compartment presenting an upper surface and a lower surface,
wherein the said upper surface of the upper compartment consists of a closable opening; and
b) a circularly built lower compartment presenting an upper surface and a lower surface, wherein the said upper surface of the said circularly built lower compartment is attached at the said lower surface of the said elongated rectangularly built upper compartment,
wherein the said circularly built lower compartment has a closable opening around the outer circumference of the said circularly built lower compartment,
wherein the said upper surface of the said circularly built lower compartment further includes plurality of handle means that are useful to carry the bag in a balanced manner,
wherein the said lower surface of the said circularly built lower compartment further includes plurality of knob means that are useful to protect the said lower surface of the said circularly built lower compartment and the whole microphone stand bag assembly.

2. The microphone stand bag assembly of claim 1,
wherein the said elongated rectangularly built upper compartment is useful to store the boom and other elongated apparatus of the microphone stand.

3. The microphone stand bag assembly of claim 1,
wherein the said circularly built lower compartment is useful to store the base of the microphone stand.

4. The microphone stand bag assembly of claim 1,
wherein the said closable opening of the said upper compartment and the said lower compartment is secured using at least one zipper device consisting of two flexible strips of metal or plastic with interlocking projections closed or opened by pulling a slide along them.

5. The microphone stand bag assembly of claim 1,
wherein the interior of the said upper compartment and the said lower compartment is formed of a heavy-duty form material that acts as a shockproof and keeps all the parts of the microphone stand safe and undamaged even in a long period of travel.
